(19) United States
(12) Patent Application Publication
(10) Pub. No.: US 2006/0183037 A1
(43) Pub. Date: Aug. 17, 2006

(54) Color layer material, color filter substrate, electro-optic device and electronic device, fabrication method of color filter substrate, and manufacturing method of electro-optic device

(76) Inventor: Keiji Takizawa, Hotaka (JP)

Correspondence Address: HARNESS, DICKEY & PIERCE, P.L.C., P.O. BOX 828, BLOOMFIELD HILLS, MI, 48303, US

(21) Appl. No.: 11/388,069

(22) Filed: Mar. 23, 2006

Related U.S. Application Data
(62) Division of application No. 10/646,335, filed on Aug. 22, 2003.

(30) Foreign Application Priority Data
Aug. 27, 2002 (JP) 2002-246917
Jul. 15, 2003 (JP) 2003-197278

(51) Int. Cl. G02B 5/20

(52) U.S. Cl. 430/7; 359/891

(57) ABSTRACT

A liquid crystal device has a liquid crystal panel having liquid crystals sandwiched between a counter substrate and a color filter substrate. A backlight using a white LED irradiates light onto the liquid crystal panel as a light source. The color filter substrate has a red color layer, a blue color layer and a green color layer. The red color layer has an average light transmittance of 2% or less in a wavelength band of 500 to 575 nm.

### CROSS-REFERENCE TO RELATED APPLICATIONS

This is a divisional application of U.S. Ser. No. 10/646,335 filed Aug. 22, 2003, which claims priority to Japanese Application No. 2002-246917 filed Aug. 27, 2002 and Japanese Application No. 2003-197278 filed Jul. 15, 2003. The disclosures of the above applications are incorporated herein by reference.

### BACKGROUND OF THE INVENTION

1. Field of the Invention

The present invention relates to a color layer material for use in a color electro-optic device using a backlight, a color filter substrate, an electro-optic device and an electronic device using the same, a fabrication method of a color filter substrate, and a manufacturing method of an electro-optic device.

2. Related Art

A color electro-optic device provided with a backlight, for example, a color liquid crystal device is configured in which, for instance, liquid crystal as an electro-optic material is sandwiched between a color filter substrate and a counter substrate, both substrates facing each other. Conventionally, as the backlight, a backlight unit of an edge light system (or side light system) is used in which a cold cathode fluorescent tube (CCFT) being a light source is disposed on the side of a light guide plate. However, the cold cathode fluorescent tube has various problems such as poor lighting properties, the necessity of an exclusive drive circuit, the difficulty in controlling light quantity, large power consumption, large amounts of heat and noises, and weakness to vibrations and impact.

Correspondingly, as the backlight without such problems, a backlight where a white LED (light emitting diode) is used as a light source is widely used in recent years. The white LED is that obtains white light by mixing blue and yellow of YAG (Yttrium Aluminum Garnet) on the surface of a blue LED.

However, in the color liquid crystal device using the backlight where the white LED is used as the light source, when a color filter substrate assembled in the color liquid crystal device using the backlight where the cold cathode fluorescent tube is used as the light source is used as it is as the color filter substrate, it causes a problem that the color reproducibility is deteriorated, particularly, red color reproducibility is noticeably deteriorated, to degrade the display quality of the liquid crystal device.

The invention attempts to solve the above mentioned problems. An object thereof is to provide a color layer material for a color filter substrate suitable for a color electro-optic device using a white LED as a backlight, a color filter substrate, an electro-optic device and an electronic device using the color filter substrate, a fabrication method of a color filter substrate, and a manufacturing method of an electro-optic device.

### SUMMARY

In order to solve the above mentioned problems, a color layer material of the invention, onto which light is irradiated by a lighting system using a light emitting diode as a light source, is characterized by having a resin, and a red color pigment having a particle diameter of 0.01 to 0.1 μm dispersed at a ratio of 5 to 10% in the resin.

According to this configuration of the invention, the color layer material can be obtained which is suitable for use in the electro-optic device having the lighting system where the light emitting diode is used as the light source. More specifically, the red color layer material where the particle diameter and dispersed ratio of the red color pigment are defined as described above is used in the electro-optic device having the lighting system where the light emitting diode is used as the light source. Therefore, an electro-optic device excellent in color reproducibility, particularly in red color reproducibility with superior display quality can be obtained.

A color filter substrate of the invention, onto which light is irradiated by a lighting system using a light emitting diode as a light source and a red color layer is disposed on the substrate, is characterized in that the red color layer has a resin, and a red color pigment having a particle diameter of 0.01 to 0.1 μm dispersed at a ratio of 5 to 10% in the resin.

According to this configuration of the invention, the color filter substrate can be obtained which is suitable for use in the electro-optic device having the lighting system where the light emitting diode is used as the light source. More specifically, the color filter substrate having the red color layer where the particle diameter and dispersion ratio of the red color pigment are defined as described above is used in the electro-optic device having the lighting system where the light emitting diode is used as the light source. Therefore, an electro-optic device excellent in color reproducibility, particularly in red color reproducibility with superior display quality can be obtained.

In addition, another color filter substrate of the invention, onto which light is irradiated by a lighting system using a light emitting diode as a light source and a red color layer is disposed on the color filter substrate, is characterized in that an average light transmittance of the red color layer is 3% or less in a wavelength band of 500 to 575 nm.

According to this configuration of the invention, the color filter substrate can be obtained which is suitable for use in the electro-optic device having the lighting system where the light emitting diode is used as the light source. More specifically, the color filter substrate provided with the red color layer where the average light transmittance is 3% or less in the wavelength band of 500 to 575 nm is used in the electro-optic device having the lighting system where the light emitting diode is used as the light source. Therefore, an electro-optic device excellent in color reproducibility, particularly in red color reproducibility with superior display quality can be obtained. Here, when the color filter substrate provided with the red color layer where the average light transmittance is greater than 3% in the wavelength band of 500 to 575 nm is used in the electro-optic device having the lighting system where the light emitting diode is used as the light source, the color desired to be displayed in red looks orange and the display quality is degraded. However, the average light transmittance of the red color layer is formed to be 3% or less in the wavelength band of 500 to 575 nm, thereby allowing the display quality to be excellent.

Furthermore, still another color filter substrate of the invention, onto which light is irradiated by a lighting system using a light emitting diode as a light source and a color layer is disposed on the substrate, is characterized in that an average light transmittance of the red color layer is 2% or less in a wavelength band of 550 to 570 nm.

According to this configuration of the invention, the color filter substrate can be obtained which is suitable for use in the electro-optic device having the lighting system where the light emitting diode is used as the light source. More specifically, the color filter substrate provided with the red color layer where the average light transmittance is 2% or less in the wavelength band of 550 to 570 nm is used in the electro-optic device having the lighting system where the light emitting diode is used as the light source. Therefore, an electro-optic device excellent in color reproducibility, particularly in red color reproducibility with superior display quality can be obtained. Here, when the color filter substrate provided with the red color layer where the average light transmittance is greater than 2% in the wavelength band of 550 to 570 nm is used in the electro-optic device having the lighting system where the light emitting diode is used as the light source, the color desired to be displayed in red looks orange and the display quality is degraded. However, the average light transmittance of the red color layer is formed to be 2% or less in the wavelength band of 550 to 570 nm, thereby allowing the display quality to be even more excellent.

Moreover, yet another color filter substrate of the invention, onto which light is irradiated by a lighting system using a light emitting diode as a light source and a red color layer is disposed on the substrate, is characterized in that a light transmittance of the red color layer is 2% or less in a wavelength of 550 nm, and a light transmittance is 55% or greater in a wavelength of 600 nm.

According to this configuration of the invention, the color filter substrate can be obtained which is suitable for use in the electro-optic device having the lighting system where the light emitting diode is used as the light source. More specifically, the color filter substrate provided with the red color layer where the light transmittance is 2% or less in the wavelength of 550 nm and the light transmittance is 55% or greater in the wavelength of 600 nm is used in the electro-optic device having the lighting system where the light emitting diode is used as the light source. Therefore, an electro-optic device excellent in color reproducibility, particularly in red color reproducibility with superior display quality can be obtained. Conventionally, the red color layer of the color filter substrate for use in the electro-optic device having the lighting system where the cold cathode fluorescent tube is used as the light source has, for example, the light transmittance of about 10% in the wavelength of 550 nm, and the light transmittance of about 80% in the wavelength of 600 nm. When the color filter substrate having such light transmittance properties is used in the electro-optic device having the lighting system where the light emitting diode is used as the light source, there is a problem that the color desired to be displayed in red looks orange and the display quality is degraded. Correspondingly, in the invention, the light transmittance of the wave length of 550 nm of the red color layer which is near the green wave band is lowered 2% or less, and the color filter substrate provided with the red color layer having such properties is used in the electro-optic device having the lighting system where the light emitting diode is used as the light source, thereby allowing preferable red color to be displayed and the display quality to be excellent.

Additionally, still yet another color filter substrate of the invention, onto which light is irradiated by a lighting system using a light emitting diode as a light source and a red color layer is disposed on the substrate, is characterized in that x ranges from 0.45 to 0.65 and y ranges from 0.28 to 0.33 in chromaticity coordinates of the light irradiated from the lighting system and passing through an area of the red color layer of the color filter substrate.

According to this configuration of the invention, the color filter substrate can be obtained which is suitable for use in the electro-optic device having the lighting system where the light emitting diode is used as the light source. More specifically, the color filter substrate where x ranges from 0.45 to 0.65 and y ranges from 0.28 to 0.33 in the chromaticity coordinates of the light passing through the area of the red color layer is used in the electro-optic device having the lighting system where the light emitting diode is used as the light source. Therefore, an electro-optic device excellent in color reproducibility, particularly in red color reproducibility with superior display quality can be obtained. Here, in the case where x ranges from 0.45 to 0.65, red is recognized as orange by visual observations when y is greater than 0.33, whereas it is recognized as magenta by visual observations when y is smaller than 0.28. Y is set to range from 0.28 to 0.33, thereby allowing it to be recognized as red by visual observations.

An electro-optic device of the invention is characterized by including the color filter substrate described above; a counter substrate disposed as facing the color filter substrate; an electro-optic material sandwiched between the color filter substrate and the counter substrate; and a lighting system using a light emitting diode as a light source for irradiating light onto the color filter substrate and the counter substrate sandwiching the electro-optic material.

According to this configuration of the invention, an electro-optic device excellent in color reproducibility, particularly in red color reproducibility with superior display quality can be obtained.

Furthermore, the electro-optic material is characterized in that it is liquid crystal.

In this manner, the liquid crystals can be used as the electro-optic material.

An electronic device of the invention is characterized by having the electro-optic device described above.

According to this configuration of the invention, an electronic device excellent in display quality can be obtained.

Moreover, in a fabrication method of a color filter substrate of the invention onto which light is irradiated by a lighting system using a light emitting diode as a light source and a red color layer is disposed on the substrate, the fabrication method of the color filter substrate of the invention is characterized by dispersing a red color pigment having a particle diameter of 0.01 to 0.1 μm at a ratio of 5 to 10% in a resin to form the red color layer.

Moreover, a manufacturing method of an electro-optic device of the invention is characterized by using the fabrication method of the color filter substrate according to the invention.

### BRIEF DESCRIPTION OF THE DRAWINGS

FIG. 1 is a schematic cross section illustrating the liquid crystal device of the first embodiment;

FIG. 2 is a schematic perspective view for illustrating the positional relationship among the reflective film, the color layer and the second electrode in the color filter substrate of the liquid crystal device shown in FIG. 1;

FIG. 3 is an exploded perspective view illustrating the backlight;

FIG. 4 is a front view illustrating the LED array;

FIG. 5(a) is a plan view illustrating the light guide plate and FIG. 5(b) is a side view illustrating the light guide plate;

FIG. 6 is a diagram illustrating the optical property of the red color layer material for the white LED;

FIG. 7 is a diagram illustrating the optical property of the red color layer material for the cold cathode fluorescent tube;

FIG. 8 is a diagram illustrating the spectral characteristic of the white LED;

FIG. 9 is a diagram illustrating the spectral characteristic of the cold cathode fluorescent tube;

FIG. 10 is a diagram illustrating a state in evaluating the color filter substrate;

FIG. 11 is a schematic cross section illustrating the liquid crystal device in the second embodiment;

FIG. 12 is a perspective view illustrating the mobile computer of the embodiment of the electronic device according to the invention;

FIG. 13 is a perspective view illustrating the mobile phone of another embodiment of the electronic device according to the invention; and

FIG. 14 is a perspective view illustrating the digital still camera of still another embodiment of the electronic device according to the invention.

### DETAILED DESCRIPTION

Color Layer Material and Color Filter Substrate

First, the principle of the invention will be described. For example, the backlight for use in the liquid crystal device as the electro-optic device is generally configured of a light source and a light guide plate for irradiating light from the light source onto the backside of a liquid crystal panel.

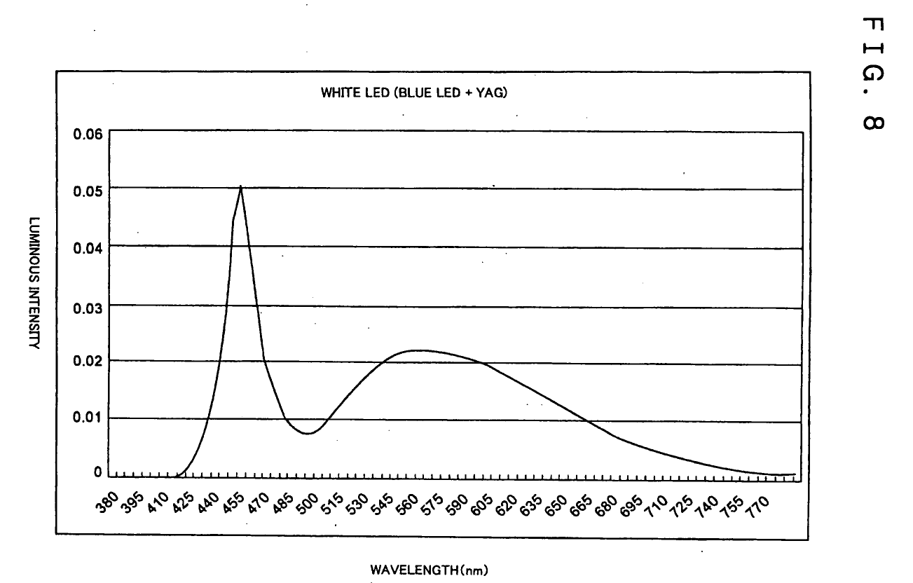

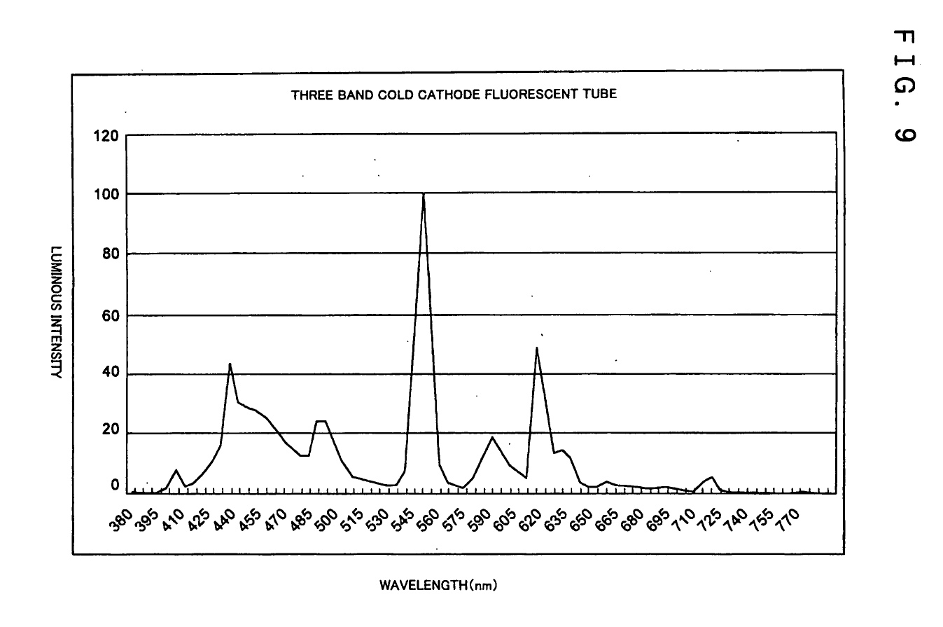

As the light source, the cold cathode fluorescent tube and the white LED are used. The white LED used in the invention has the spectral characteristic shown in FIG. 8, and the cold cathode fluorescent tube has the spectral characteristic shown in FIG. 9. As apparent from FIGS. 8 and 9, the respective spectral characteristics of the white LED and the cold cathode fluorescent tube are different. As such, when the color filter substrate, which is assembled in the color liquid crystal device using the backlight where the cold cathode fluorescent tube is the light source, is used as it is as the color filter substrate for the color liquid crystal device using the backlight where the white LED is the light source, it causes a problem that the color reproducibility is deteriorated, and particularly, the color desired to be originally displayed in red looks magenta.

Thus, in the invention, the optical property of a red color layer is controlled in the color filter substrate of the color electro-optic device using the backlight where the white LED is the light source. More specifically, for example, as a red color layer material (hereafter, it is a red color layer material for the white LED) of the color filter substrate in the color electro-optic device using the backlight where the white LED is the light source, a material of a red pigment having a particle diameter of 0.01 to 0.1 μm dispersed in an acrylic resin at a ratio of 5 to 10% (made by FUJIFILM Arch Co., LTD. (the trade name of Color Mosaic CR-9500)) was used. Additionally, a red color layer material (hereafter, a red color layer material for the cold cathode fluorescent tube) of the color filter substrate assembled in the color liquid crystal device using the backlight where the cold cathode fluorescent tube is the light source is, for example, a red color layer material of a red color pigment having a particle diameter of 0.01 to 0.1 μm dispersed in an acrylic resin at a ratio of 5 to 10% (made by FUJIFILM Arch Co., LTD. (the trade name of Color Mosaic CR-8510)).

The optical property of the color filter substrate where light is irradiated from the backlight using the white LED onto the above mentioned color filter substrate using the red color layer material for the white LED was that x ranges from 0.45 to 0.65 and y ranges from 0.28 to 0.33 according to the chromaticity coordinates established by International Commission on Illumination (CIE) as the result of using Luminance meter BM5A (made by TOPCON Corporation) for measurement.

Furthermore, as the result that the quantity ratio of the pigment in the red color layer material was varied and measured similarly, it was revealed that, in the case where x ranges from 0.45 to 0.65, the color is recognized as red by visual observations when y ranges from 0.28 to 0.33, it is recognized as orange by visual observations when y is greater than 0.33, and it is recognized as magenta by visual observations when y is smaller than 0.28.

Accordingly, the optical property of the color filter substrate is set where x ranges from 0.45 to 0.65 and y ranges from 0.28 to 0.33 in a stimulus value (red) when the light is irradiated from the backlight using the white LED, thereby allowing red color display to be obtained when the liquid crystal device is formed.

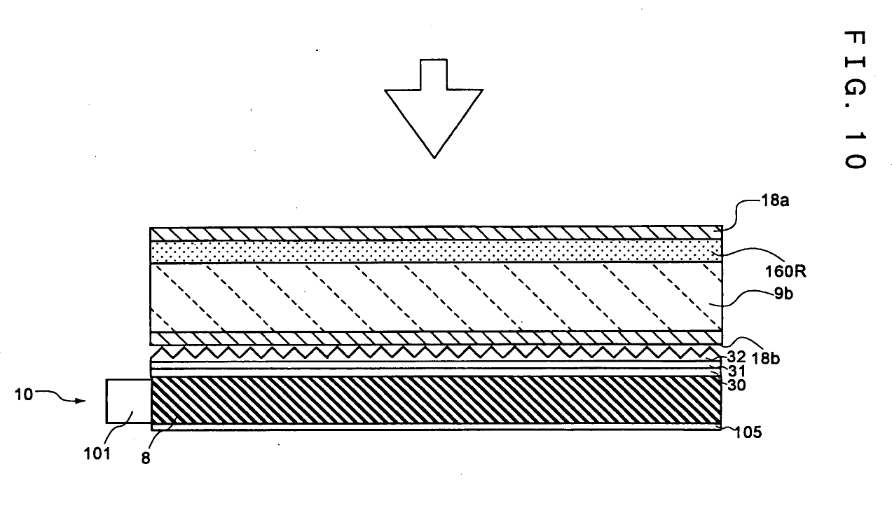

In addition, the measurements by the Luminance meter BM5A and visual observations were all conducted under the condition shown in FIG. 10. More specifically, a color filter substrate was prepared in which the red color layer material described above was applied on a glass substrate 9b having a thickness of 0.7 mm (made by Nippon Sheet Glass Co., Ltd. (the trade name of OA10)), and then a color layer 160R having a thickness of 1 μm was baked and cured. Subsequently, as shown in FIG. 10, the color filter substrate is sandwiched by a polarizer 18a and a polarizer-DBEF integrated sheet 18b combined with a polarizer and a DBEF (Dual Brightness Enhancement Film). Furthermore, a backlight 10 using the white LED as the light source was disposed on the polarizer-DBEF integrated sheet 18b side, a diffuser 30, a BEF (Brightness Enhancement Film) sheet 31 and a BEF (Brightness Enhancement Film) sheet 32 orthogonal to the BEF sheet 31 were disposed between the backlight 10 and the polarizer 18b, and then the backlight 10 was turned on. Then, light emitted from the backlight 10 and then passed through the diffuser 30, the BEF sheet 31, the BEF sheet 32, the polarizer-DBEF integrated sheet 18b, the color filter substrate and the polarizer 18a was measured by the Luminance meter BM5A (made by TOPCON Corporation) or observed by visual observations. Furthermore, since the detailed structure of the backlight 10 will be described in a first embodiment in an electro-optic device, which will be described later, it is omitted here.

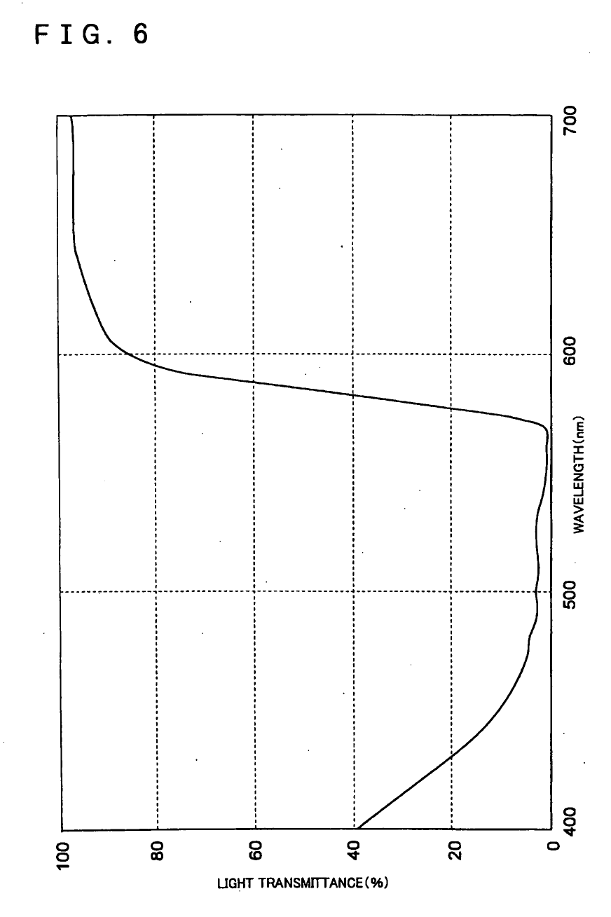

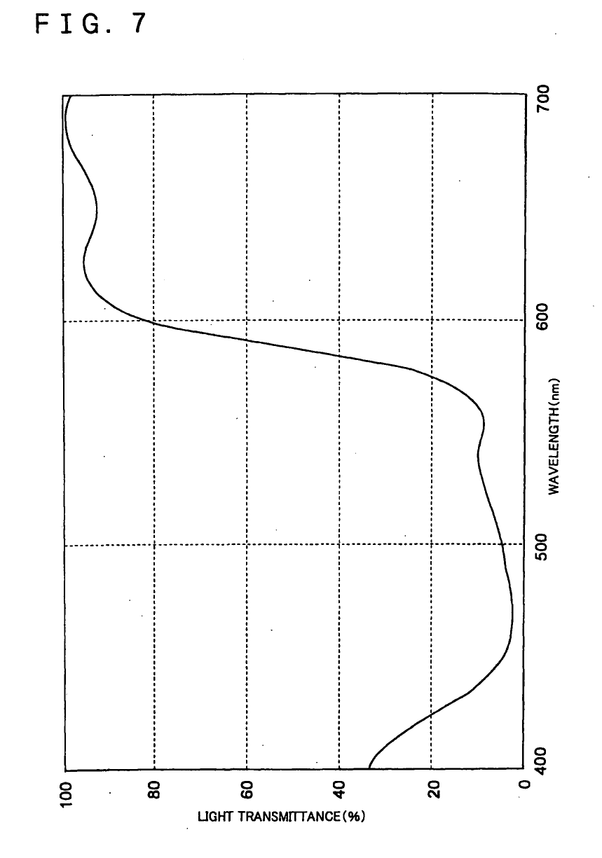

Next, the difference between the optical properties of the above mentioned red color layer material for the white LED and the red color layer material for the cold cathode fluorescent tube will be described with FIGS. 6 and 7. FIG. 6 shows the optical property of the red color layer material for the white LED, and FIG. 7 shows the optical property of the red color layer material for the cold cathode fluorescent tube, both showing the relationship between the wavelengths and the light transmittance.

In measuring the optical properties of the red color layer materials shown in FIGS. 6 and 7, a color filter substrate was first prepared in which a red color layer material was applied on a glass substrate having a thickness of 0.7 mm (made by Nippon Sheet Glass Co., Ltd. (the trade name of OA10)), and then a color layer having a thickness of 1 μm was baked and cured. Subsequently, the light from a light source C was irradiated onto the color filter substrate from the glass substrate side, and the light passed through the glass substrate and the color layer was measured by Olympus Spectrometer OSPSP200. As apparent from FIGS. 6 and 7, the red color layer for the white LED has the light transmittance near wavelengths of 500 to 575 nm lower than that of the red color layer for the cold cathode fluorescent tube. In this manner, the color filter substrate having the red color layer where the average light transmittance is 3% or less in the wavelength band of 500 to 575 nm, more preferably, the average light transmittance is 2% or less in the wavelength band of 550 to 570 nm, or having the red color layer where the light transmittance is 2% or less in a wavelength of 550 nm and the light transmittance is 55% or greater in a wavelength of 600 nm is used for an electro-optic device. Therefore, near the area from yellow to orange, in other words, the light transmittance of the wavelengths in the area near the green wave band of the red color layer is reduced, preferable red color display can be obtained in the electro-optic device having the backlight using the white LED, and an electro-optic device excellent in color reproducibility can be obtained.

Electro-optic Device as a First Embodiment

Hereafter, the electro-optic device using the above mentioned color filter substrate provided with the red color layer for the white LED will be described.

In the embodiment, the case adapted to an active matrix semi-transmissive liquid crystal device of COG system where a TFD element is used as a switching element is exemplified as the electro-optic device, which will be described with the drawings. In addition, in the drawings, the contraction scales or numbers are different in the actual structure and each configuration for easily understanding each configuration.

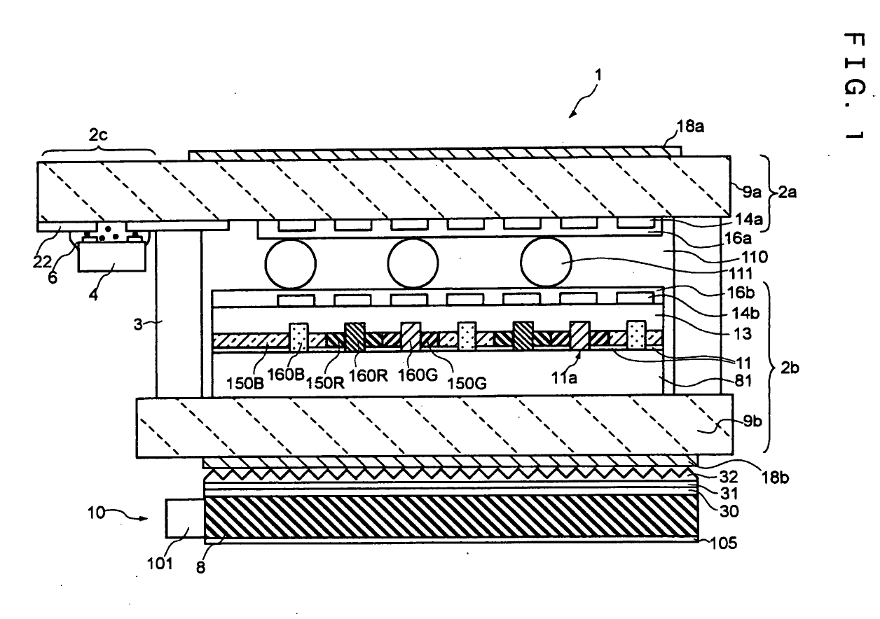

FIG. 1 is a schematic cross section illustrating one embodiment of the liquid crystal device.

A liquid crystal device 1 shown in FIG. 1 is formed by bonding, more specifically, attaching a counter substrate 2a to a color filter substrate 2b with a sealing material 3. The area surrounded by the sealing material 3, the counter substrate 2a and the color filter substrate 2b forms a space having a fixed height, so-called a cell gap. Additionally, a liquid crystal filling port is formed in a part of the sealing material 3. Liquid crystals 110 as an electro-optic material are filled in the above mentioned cell gap through the above mentioned liquid crystal filling port, and the liquid crystal filling port is sealed with a resin etc. after they are filled completely. The space between the counter substrate 2a and the color filter substrate 2b is held by spacers 111.

Furthermore, on the backside of the color filter substrate 2b (the bottom side of the structure shown in FIG. 1), a backlight 10 as a lighting system having an LED array 101 as a light source part, a light guide plate 8 onto which light is irradiated from the LED array 101 and a reflector 105 are disposed. Between the backlight 10 and a polarizer-DBEF integrated sheet 18b where a polarizer is combined with a DBEF (Dual Brightness Enhancement Film) in one piece disposed adjacently to the color filter substrate 2b, which will be described later, a diffuser 30, a BEF (Brightness Enhancement Film) sheet 31 and a BEF (Brightness Enhancement Film) sheet 32 are disposed. Moreover, the diffuser 30 is that diffuses light emitted from the light guide plate and changes its traveling direction. The BEF sheets 31 and 32 are that they are combined with the diffuser 30 to control the light distribution properties of the backlight for improving the luminance on the front side, and the BEF sheets 31 and 32 are disposed so as to orthogonal to each other.

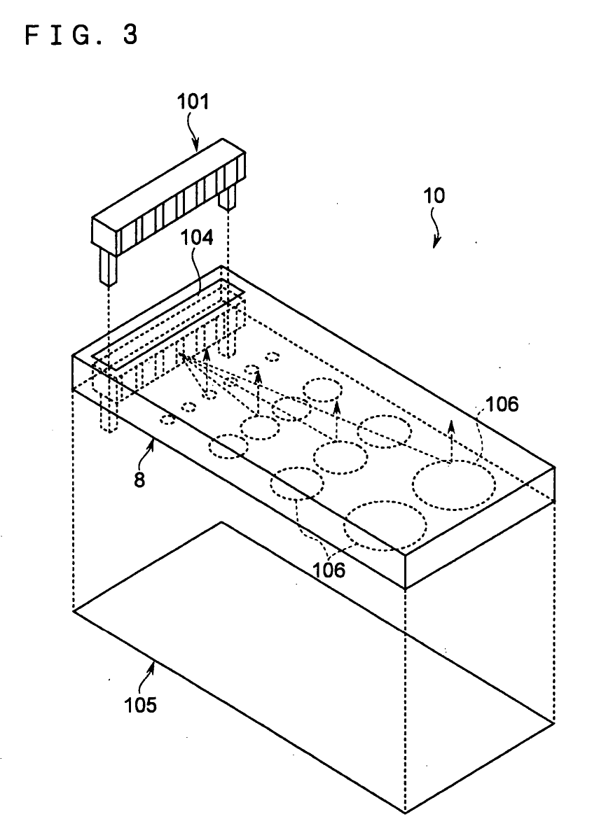

The above mentioned backlight 10 will be described with FIGS. 3 to 5. FIG. 3 is a schematic diagram illustrating the backlight.

As shown in FIG. 3, the backlight 10 mainly has the LED array 101 operating as the light source part, the light guide plate 8 and the reflector 105.

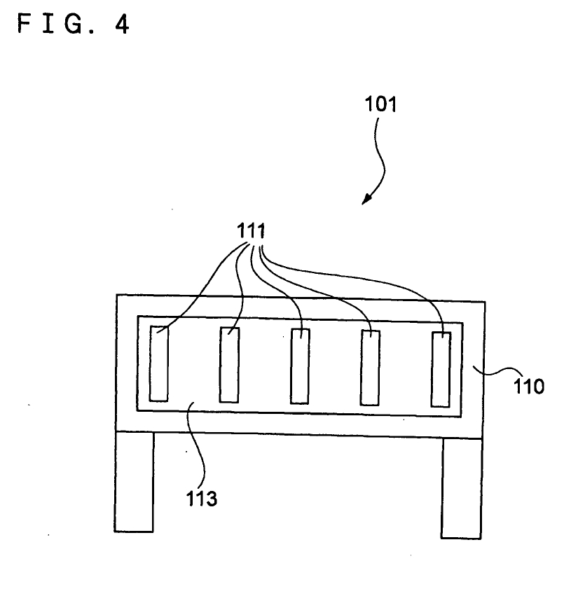

FIG. 4 shows the configuration of the LED array 101. FIG. 4 is a front view illustrating the LED array 101 seen from the light emitting surface side. As shown in FIG. 4, a plurality of LEDs 111 is placed inside a casing 110 in the LED array 101. Each of the LED 111 is disposed so as to orient the light emitting surface outside. Then, a fluorescent filter 113 is mounted on the casing 110 in front of the light emitting surface of each of the LED 111.

The LED array 101 is the white LED described above, and each of the LEDs 111 is, for example, an InGaN-based or GaN-based LED for emitting blue light (for example, a wavelength of 470 nm). In addition, the fluorescent filter 113 is a wavelength conversion filter that receives blue light from the LED 111 and emits blue light, green light and red light. The fluorescent filter 113 can be formed by, for example, those adding a predetermined rare-earth element in a base of oxide glass or by a phosphor made of a light blocking organic polymer. Furthermore, not shown in the drawing, a control circuit for controlling current quantity for lighting the LED array 101 is connected.

According to the LED array 101 thus configured, the blue light emitted from each of the LEDs 111 is converted in the wavelength by the fluorescent filter 113 to generate three primary colors, red, green and blue. Consequently, the light outputted from the LED array 101 is white light.

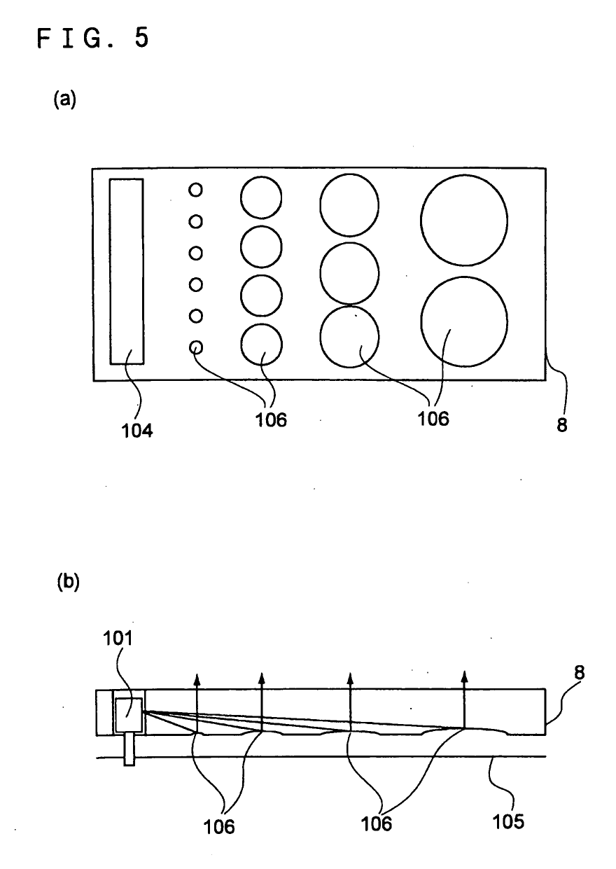

Next, the configuration of the light guide plate 8 is shown in FIGS. 5(a) and 5(b). FIG. 5(a) is a plan view illustrating the light guide plate 8, and FIG. 5(b) is a side view. As shown in FIGS. 5(a) and 5(b), the light guide plate 8 has a mounting hole 104 on its one end for mounting the LED array 101. Additionally, on the surface of the light guide plate 8, a plurality of light diffusion parts 106 formed of recess of large and small bumps and dips are formed. Furthermore, the light guide plate 8 is formed of transparent resins such as polymethyl methacrylate (PMMA) resin and polycarbonate resin.

When current is carried through each of the LEDs 111 of the LED array 101 by the control circuit with the LED array 101 mounted in the mounting hole 104 of the light guide plate 8, each of the LEDs in the LED array 101 emits light and white light is outputted from the whole surface of the LED array 101 by the operation of the fluorescent filter 113. As shown in FIG. 5(b), the white light emitted from the LED array 101 enters the light guide plate 8, propagates through the inside of the light guide plate 8, and is irradiated to information of the light guide plate 8 by reflection of the reflector 105 or by diffusion of the light diffusion parts 106

In FIG. 1, the counter substrate 2a has a substrate extension part 2c which is extended outside the second substrate 2b, and a liquid crystal drive IC 4 is mounted on the substrate extension part 2c with a conductive adhesive material, for example, an ACF (Anisotropic Conductive Film) 6.

The counter substrate 2a has a substrate 9a, and a plurality of pixel electrodes 14a is disposed on the surface of the substrate 9a, that is, the surface on the liquid crystals 110 side. In addition, on the inner surface of the opposite substrate 2a, a plurality of linear line wirings (not shown) is disposed in stripes in parallel with each other, TFD elements (not shown) are placed so as to conduct to the line wirings, and a plurality of pixel electrodes 14a is disposed in a matrix via the TFD elements.

Furthermore, an alignment layer 16a is disposed on the pixel electrodes 14a, the TFD elements and the line wirings. Moreover, the polarizer 18a is disposed on the outer surface of the substrate 9a.

The color filter substrate 2b has a substrate 9b. A scattering resin layer 81 is disposed on the surface of the substrate 9b on the liquid crystals 110 side, and a reflective film 11 made of a light reflective material such as Al is disposed on the scattering resin layer 81. In addition, not shown in the drawings, the surface of the scattering resin layer 81 adjacent to the reflective film 11 has bumps and dips. The reflective film 11 is deposited along the bumps and dips, and the surface of the reflective film 11 is in a state of having the bumps and dips. Furthermore, openings 11a for transmitting light at every single dot are formed in the reflective film 11. More specifically, in the case of functioning as the reflective liquid crystal device for display by utilizing outside light, the outside light entered the liquid crystal device 1 is reflected on the reflective film 11, and the reflected light is used for display. In the case of functioning as the transmissive liquid crystal device for display by utilizing the backlight 10, display is performed by transmitting the light emitted from the backlight 10 through the openings 11a formed in the reflective film 11. Moreover, in the embodiment, the semi-transmissive reflective functions are attained by disposing the openings in a part of the reflective film 11. However, for example, the semi-transmissive reflective functions can also be attained by forming the thickness of the reflective film thin to the extent that light can be transmitted.

Additionally, a color filter film and an overcoat layer 13 to cover the color filter film are disposed on the reflective film 11, second electrodes 14b are disposed thereon, and an alignment layer 16b is further disposed thereon. Furthermore, the polarizer-DBEF integrated sheet 18b is disposed on the outer surface of the substrate 9b.

The second electrodes 14b are formed in stripes by arranging a plurality of linear electrodes in parallel with each other so as to cross the line wirings.

The intersections of the pixel electrodes 14a and the second electrodes 14b are arranged in a dot matrix. Each of the intersections forms a single dot, and each of the color layer patterns of the color filter film corresponds to the single dot.

The color filter film described above forms a single pixel as three primary colors of R (red), G (green) and B (blue) form a single unit. More specifically, three dots form a single unit to form a single pixel.

The color filter film in the embodiment is configured of a reflective blue color layer 150B, a reflective red color layer 150R, a reflective green color layer 150G, a non-reflective blue color layer 160B, a non-reflective red color layer 160R, and a non-reflective green color layer 160G. The above mentioned red color layer material for the white LED is used for the non-reflective red color layer 160R.

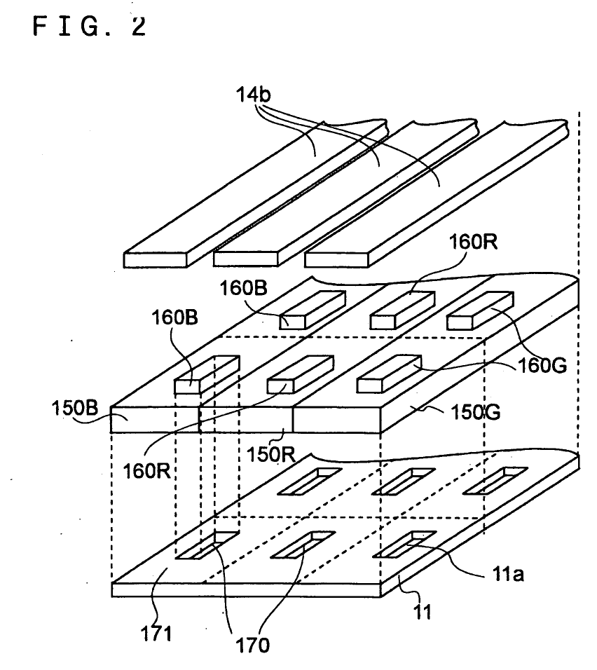

Next, the positional relationship between the color filter film and the reflective film and the construction thereof will be described with FIGS. 1 and 2. FIG. 2 is a schematic perspective view illustrating the positional relationship among the reflective film 11, each color layer and the second electrodes 14b in the color filter substrate 2b of the liquid crystal device 1 shown in FIG. 1. As shown in the drawing, the liquid crystal device 1 has the structure in which one opening 11a of the reflective film 11 is formed at every single dot. The structure of the reflective film 11 corresponding to a single dot is that the reflective film 11 placed in a reflective area 171 used for reflection is disposed so as to surround the openings 11a placed in non-reflective areas 170 for transmission. Additionally, the reflective blue color layer 150B, the reflective red color layer 150R and the reflective green color layer 150G are formed in stripes nearly along the second electrodes 14b, and the color layers are not formed at the positions corresponding to the openings 11a of the reflective film 11. On the other hand, the non-reflective blue color layer 160B, the non-reflective red color layer 160R and the non-reflective green color layer 160G are formed corresponding to the openings 11a of the reflective film 11 so as to linearly arrange the same colors nearly along the second electrodes 14b. The reflective color layers 150 are varied from the non-reflective color layers 160, or the transparent color layers, in color layer materials and thickness. In the embodiment, the reflective color layers 150 are formed in a thickness of 1 μm, whereas the non-reflective color layers 160 are formed in a thickness of 1.5 μm.

The above mentioned substrates 9a and 9b are formed of, for example glass and plastic. Furthermore, in the above mentioned electrodes 14a and 14b, for example, ITO (Indium Tin Oxide) is deposited by well-known deposition methods such as sputtering and vacuum deposition, and a desired pattern is further formed by photo-etching.

The alignment layers 16a and 16b are formed by, for example, a method of coating a polyimide solution and then baking it or by offset printing.

The liquid crystal device 1 in the embodiment performs display by semi-transmissive reflective display. In the case of reflective display in the semi-transmissive reflective display, the light taken from the outside of the counter substrate 2a in FIG. 1 is reflected by the reflective film 11 and is fed to the layer of the liquid crystals 110. In this state, voltage applied to the liquid crystals 110 is controlled at every pixel and the alignment of the liquid crystals is controlled at every pixel, thereby modulating the light at every pixel fed to the layer of the liquid crystals 110 and feeding the modulated light to the polarizer 18a. Accordingly, images such as letters are displayed. On the other hand, in the case of transmissive display, the light emitted from the backlight 10 in FIG. 1 is fed to the liquid crystal layer 110. In this state, voltage applied to the liquid crystals 110 is controlled at every pixel and the alignment of the liquid crystals is controlled at every pixel, thereby modulating the light fed to the layer of the liquid crystals 110 at every pixel and feeding the modulated light to the polarizer 18a. Accordingly, images such as letters are displayed.

In the embodiment, the color filter substrate using the optimum red color layer is used when the above mentioned backlight using the white LED for the light source is used in the electro-optic device. Therefore, red color reproducibility is excellent, and superior display quality can be obtained.

Electro-optic Device as a Second Embodiment

In the above mentioned liquid crystal device of the first embodiment, the case adapted to the semi-transmissive type is exemplified, but it is needless to say that it can also be adapted to the transmissive liquid crystal device.

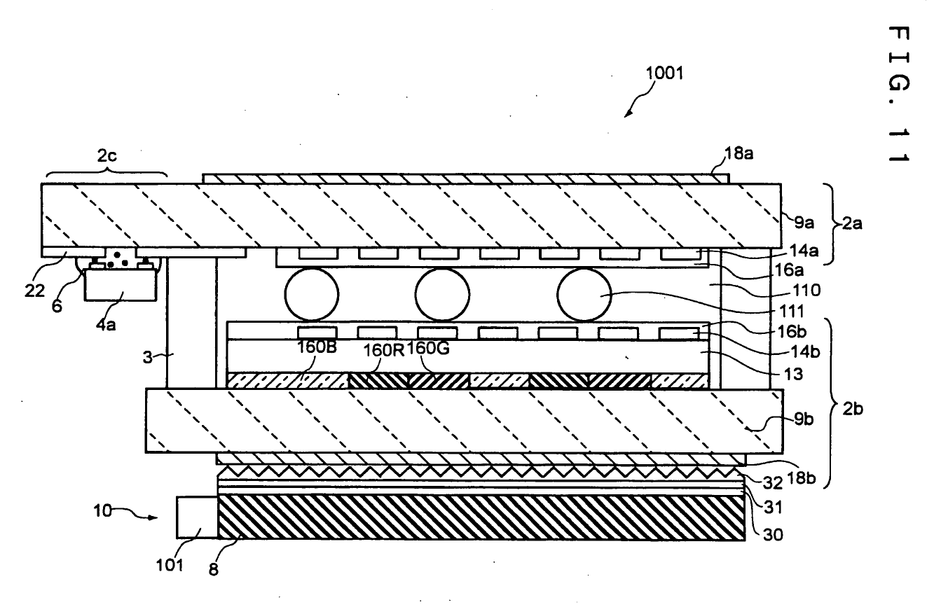

Hereafter, a transmissive liquid crystal device 1001 in the second embodiment will be described with FIG. 11. FIG. 11 is a cross section illustrating the transmissive liquid crystal device 1001. In addition, the liquid crystal device 1001 in the second embodiment is varied in that the structure of the color filter substrate is different as compared with the liquid crystal device 1 of the first embodiment. Hereinafter, the same structure as that of the first embodiment is omitted in the description, and the difference will be described.

The transmissive liquid crystal device 1001 in the embodiment performs display only using the backlight, without using outside light. As such, the reflective film 11, the scattering resin layer 81, and the reflective color layers 150B, 150R and 150G disposed in the liquid crystal device 1 shown in the first embodiment are not disposed in the liquid crystal device 1001 shown in the embodiment.

The color filter film in the embodiment is formed of a blue color layer 160B, a red color layer 160R and a green color layer 160G formed in stripes along second electrodes 14b, and the same material as that for the transparent color layers of the first embodiment is used for the color layer materials.

Also in the embodiment, the color filter substrate using the optimum red color layer is used when the backlight using the white LED for the light source is used in the transmissive liquid crystal device as similar to the first embodiment. Therefore, red color reproducibility is excellent, and superior display quality can be obtained.

Electronic Device as a Third Embodiment

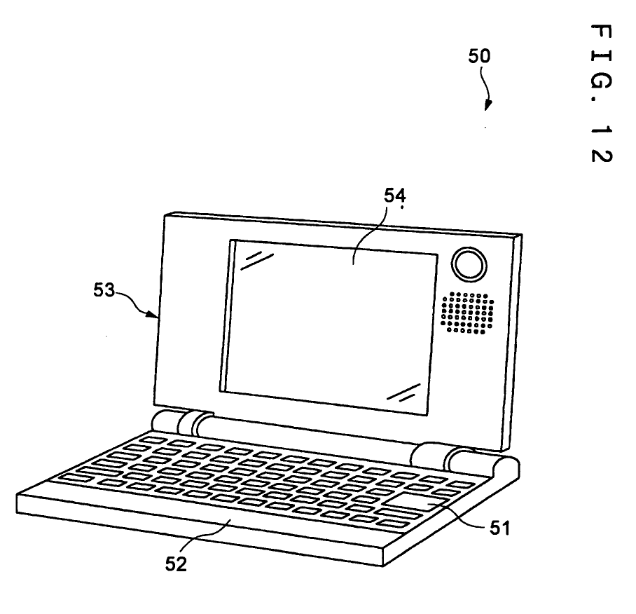

FIG. 12 shows a mobile personal computer being one embodiment of electronic devices according to the invention. A computer 50 shown here is configured of a main body part 52 having a keyboard 51 and a liquid crystal display unit 53. The liquid crystal display unit 53 has a liquid crystal device 54 incorporated in an outer frame as a housing part. The liquid crystal device 54 can be formed by using, for example, the liquid crystal device 1 shown in the first embodiment or the liquid crystal device 1001 shown in the second embodiment.

Electronic Device as a Fourth Embodiment

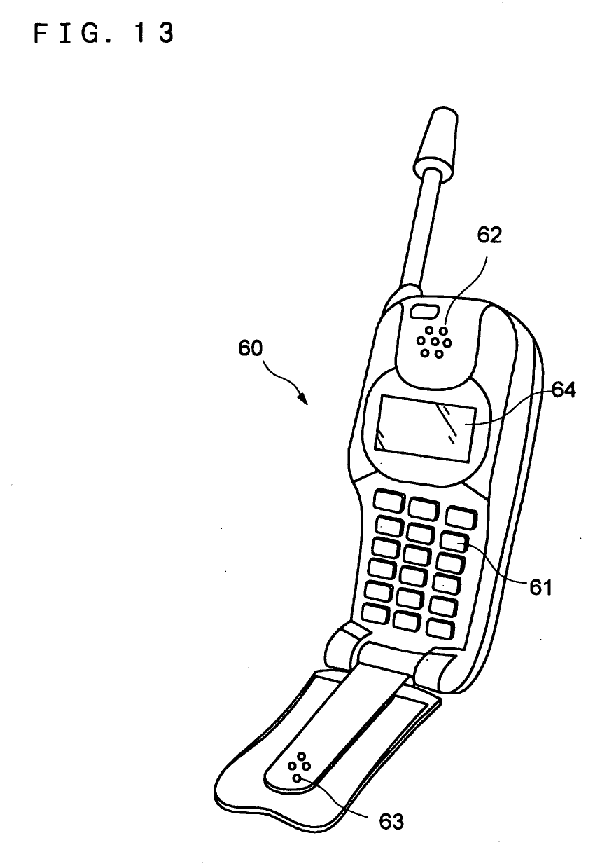

FIG. 13 shows a mobile phone being another embodiment of the electronic devices according to the invention. A mobile phone 60 shown here has a liquid crystal device 64 incorporated in an outer frame as a housing part having an ear piece 62 and a mouthpiece 63 in addition to manual operation buttons 61. The liquid crystal device 64 can be formed by using, for example, the liquid crystal device 1 shown in the first embodiment or the liquid crystal device 1001 shown in the second embodiment.

Electronic Device as a Fifth Embodiment

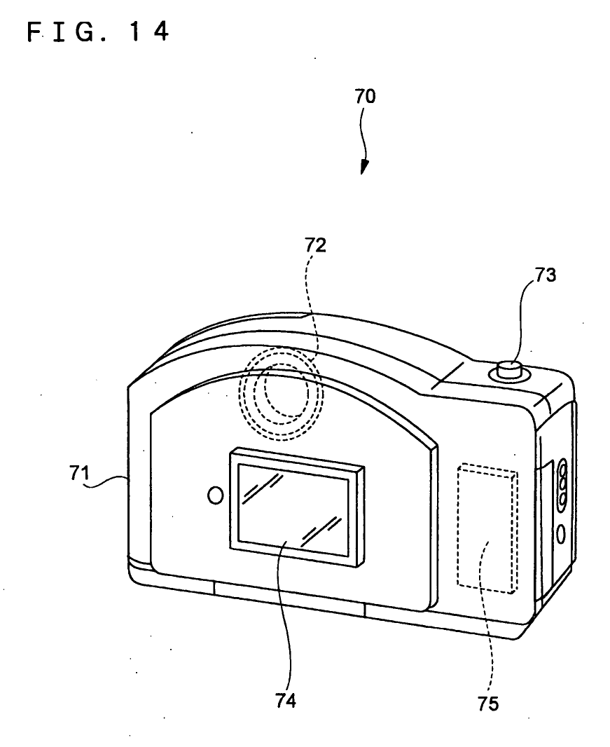

FIG. 14 shows a digital still camera being still another embodiment of the electronic devices according to the invention. A general camera exposes film by the light image of a subject, whereas a digital still camera 70 photo-electrically converts the light image of a subject by an image pickup element such as a CCD (Charge-Coupled Device) to generate image pickup signals.

Here, a liquid crystal device 74 is disposed on the backside of a case 71 as the housing of the digital still camera 70 in which configured that the display is performed based on image pickup signals by the CCD. As such, the liquid crystal device 74 functions as a viewfinder for displaying the subject. Additionally, a light receiving unit 72 including an optical lens and the CCD is disposed on the front side of the case 71 (the backside of the structure shown in FIG. 14). The liquid crystal device 74 can be formed by using, for example, the liquid crystal device 1 shown in the first embodiment or the liquid crystal device 1001 shown in the second embodiment. A person to take a picture confirms the subject displayed in the liquid crystal display device 74 and presses down a shutter button 73 for shooting.

As described above, the invention has been described by the embodiments, but the invention is not limited to the embodiments, which can be modified variously within the scope of the invention described in the scope of the claims.

For example, in the first embodiment and the second embodiment, the invention is adapted to the active matrix liquid crystal device where the TFD element is used for the switching element. However, the invention can also be adapted to the active matrix liquid crystal device having the structure where a three-terminal switching element such as a TFT is used for the switching element. Alternatively, it can also be adapted to the simple matrix liquid crystal device with no active elements, and it can be adapted to the electro-optic device using the backlight where the LED is used for the light source.

In addition, as the electronic device in the invention, a liquid crystal television, viewfinder type and monitor direct view type video tape recorders, a car navigation system, a pager, a personal digital assistant, an electronic calculator, a word processor, a workstation, a visual telephone, and a point-of-sale terminal can be named, in addition to the personal computer, the mobile phone and the digital still camera. Then, the liquid crystal device according to the invention can be used as the display part of these various electronic devices.

Furthermore, in the above mentioned embodiments, the case adapted to the liquid crystal device has been described as the electro-optic device. However, the invention is not limited to this, which can be adapted to various electro-optic devices such as an electro-luminescent device, particularly an organic electro-luminescent device and an inorganic electro-luminescent device, a plasma display device, an FED (field emission display device), a surface conduction electron emitter display device, an electrophoretic display device, a low-profile cathode-ray tube, a small-sized television with a liquid crystal shutter and the like, and a device with a digital micromirror device (DMD).

What is claimed is:

1. A color filter substrate onto which light is irradiated by a lighting system using a light emitting diode as a light source and a red color layer is disposed on the substrate, wherein the color filter substrate has an x that ranges from 0.45 to 0.65 and a y that ranges from 0.28 to 0.33 in chromaticity coordinates of the light irradiated from the lighting system and passing through an area of the red color layer of the color filter substrate.
